(19) United States
(12) Patent Application Publication
(10) Pub. No.: US 2018/0261413 A1
(43) Pub. Date: Sep. 13, 2018

(54) ELECTROMAGNETIC RELAY

(71) Applicant: EM Devices Corporation, Shiroishi-shi (JP)

(72) Inventors: Yoshiki TANAKA, Shiroishi-shi (JP); Tsutomu ONO, Shiroishi-shi (JP); Jun KONDA, Shiroishi-shi (JP); Kenichi HERAI, Shiroishi-shi (JP); Yuta SUZUKI, Shiroishi-shi (JP)

(21) Appl. No.: 15/821,126

(22) Filed: Nov. 22, 2017

(30) Foreign Application Priority Data
Mar. 10, 2017 (JP) 2017-045836

(51) Int. Cl. H01H 50/02; H01H 50/12; H01H 51/28; H01H 9/04

(52) U.S. Cl. CPC H01H 50/023; H01H 50/026; H01H 50/12; H01H 50/041; H01H 51/281; H01H 9/043; H01H 51/282

(57) ABSTRACT

An electromagnetic relay according to an aspect of the present disclosure includes a housing including a base part on which an electromagnetic relay main body is mounted, and a cover part covering the electromagnetic relay main body, in which the housing is in a sealed state when a pressure inside the housing is equal to or lower than a predetermined pressure, in which when the pressure inside the housing is equal to or lower than the predetermined pressure, the cover part and the base part are butted against each other, and the electromagnetic relay includes a connection passage connecting an abutment part between the cover part and the base part to outside of the electromagnetic relay.

### INCORPORATION BY REFERENCE

This application is based upon and claims the benefit of priority from Japanese patent application No. 2017-045836, filed on Mar. 10, 2017, the disclosure of which is incorporated herein in its entirety by reference for all purposes.

### BACKGROUND

The present disclosure relates to an electromagnetic relay including a housing including a base part on which an electromagnetic relay main body is mounted, and a cover part covering the electromagnetic relay main body, in which the housing is in a sealed state when a pressure inside the housing is equal to or lower than a predetermined pressure.

An ordinary electromagnetic relay includes a housing including a base part on which an electromagnetic relay main body is mounted, and a cover part covering the electromagnetic relay main body. Further, the housing is put in a sealed state by using a sealing resin in order to prevent the intrusion of foreign substances and the like into the housing.

Such an electromagnetic relay undergoes, for example, a reflow heating process in order to solder external terminals of an electromagnetic relay main body to a circuit board. However, since the housing is in a sealed stated as described above, the pressure inside the housing rises during the reflow heating process, thus raising a possibility that a defect such as a deformation of the housing could occur.

Therefore, for example, Japanese Unexamined Patent Application Publication No. 2011-3287 discloses an electromagnetic relay including a through hole formed in a cover part, and an internal pressure adjustment lid that is disposed in the cover part and covers the through hole, in which when the pressure inside the housing rises, the internal pressure adjustment lid deforms and thereby lets a gas contained in the housing escape through the through hole.

### SUMMARY

The present inventors have found the following problem. In the electromagnetic relay disclosed in Japanese Unexamined Patent Application Publication No. 2011-3287, it is necessary to provide the internal pressure adjustment lid in the cover part to let the gas contained in the housing escape. Therefore, in the electromagnetic relay disclosed in Japanese Unexamined Patent Application Publication No. 2011-3287, the number of components is large and the manufacturing process is complicated. As a result, the cost for manufacturing the electromagnetic relay is high.

The present disclosure has been made in the above-described background to provide an electromagnetic relay capable of suppressing a rise in a pressure inside a housing during a reflow heating process while reducing a cost for manufacturing the electromagnetic relay.

A first exemplary aspect is an electromagnetic relay including a housing including a base part on which an electromagnetic relay main body is mounted, and a cover part covering the electromagnetic relay main body, in which

the housing is in a sealed state when a pressure inside the housing is equal to or lower than a predetermined pressure, in which when the pressure inside the housing is equal to or lower than the predetermined pressure, the cover part and the base part are butted against each other, and the electromagnetic relay includes a connection passage connecting an abutment part between the cover part and the base part to outside of the electromagnetic relay.

By the above-described configuration, there is no need to provide an internal pressure adjustment lid, which is necessary in an ordinary electromagnetic relay, thus making it possible to reduce the number of components and simplify the manufacturing process. As a result, it is possible to suppress a rise in a pressure in the internal space of the housing during a reflow heating process while reducing a cost for manufacturing the electromagnetic relay.

In the above-described electromagnetic relay, the abutment part is preferably a valve mechanism configured to cut off the connection between the inside of the housing and the connection passage when the pressure inside the housing is equal to or lower than the predetermined pressure, and separate when the pressure inside the housing is higher than the predetermined pressure and thereby connect the inside of the housing with the connection passage.

In the above-described electromagnetic relay, a projection formed in the cover part is preferably engaged with a recess formed in the base part, and the abutment part is preferably an abutment surface composed of a top surface of the projection in the cover part and a bottom surface of the recess in the base part.

In the above-described electromagnetic relay, a recess formed in the cover part is preferably engaged with a projection formed in the base part, and the abutment part is preferably an abutment surface composed of a bottom surface of the recess in the cover part and a top surface of the projection in the base part.

In the above-described electromagnetic relay, the connection passage is preferably formed on a side wall of the cover part.

In the above-described electromagnetic relay, the connection passage is preferably formed in the base part.

In the above-described electromagnetic relay, the connection passage preferably extends in a direction in which an external terminal of the electromagnetic relay main body extends.

In the above-described electromagnetic relay, a heat-radiation part is preferably formed in the housing.

In the above-described electromagnetic relay, the heat-radiation part is preferably disposed near a movable contact of the electromagnetic relay main body with respect to an electromagnet of the electromagnetic relay main body.

In the above-described electromagnetic relay, the heat-radiation part is preferably disposed near the connection passage.

According to the present disclosure, it is possible to suppress a rise in a pressure inside the housing during a reflow heating process while reducing a cost for manufacturing the electromagnetic relay.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF DRAWINGS

FIG. 1 is a perspective view schematically showing an electromagnetic relay according to an embodiment;

FIG. 2 is an exploded view schematically showing the electromagnetic relay according to the embodiment;

FIG. 3 is a cross section taken along a line III-III in FIG. 1;

FIG. 4 is a cross section taken along a line IV-IV in FIG. 1;

FIG. 5 is an enlarged view showing a V-part in FIG. 3;

FIG. 6 is an enlarged view showing a VI-part in FIG. 4;

FIG. 7 is an enlarged view corresponding to FIG. 5, showing the housing in a state where in a pressure an internal space of the housing is higher than a predetermined pressure; and

FIG. 8 is an enlarged view corresponding to FIG. 6, showing the housing in a state where a pressure in an internal space of the housing is higher than a predetermined pressure.

### DESCRIPTION OF EMBODIMENTS

Specific embodiments to which the present disclosure is applied are explained hereinafter in detail with reference to the drawings. However, the present disclosure is not limited to the below-shown embodiments. Further, the following descriptions and the drawings are simplified as appropriate for clarifying the explanation.

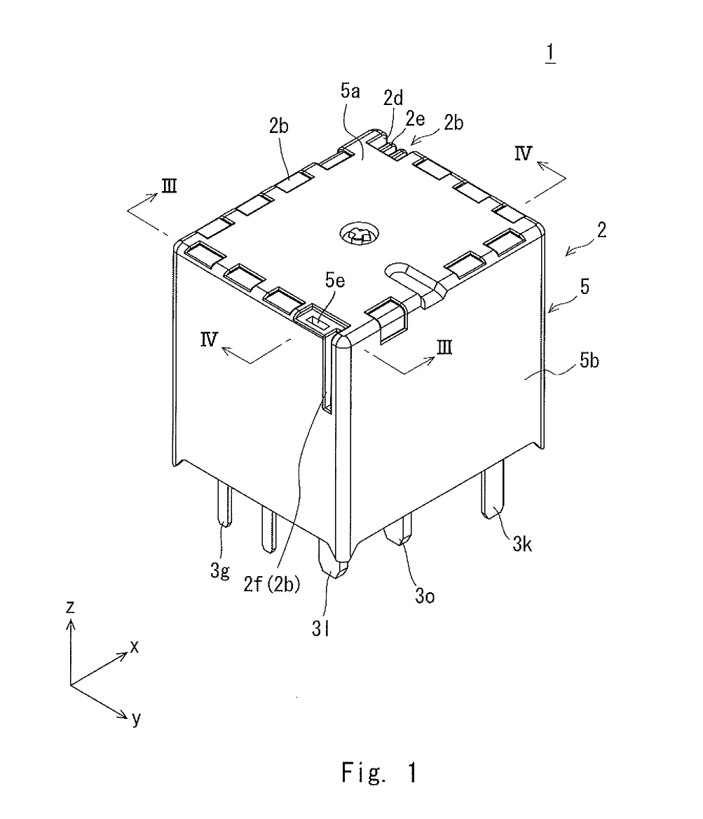

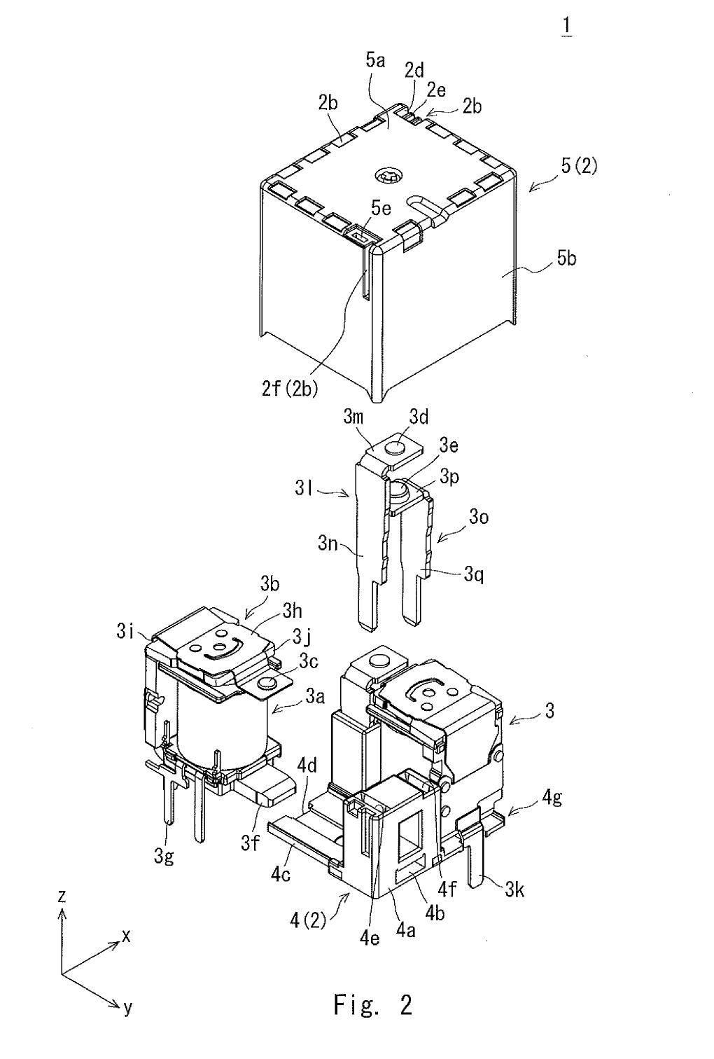

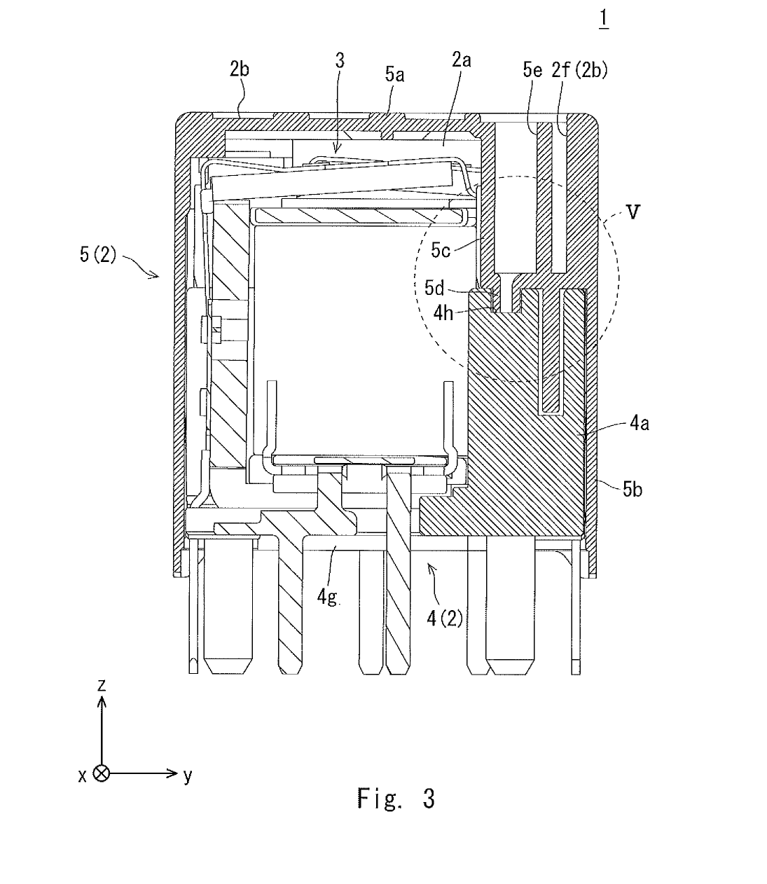

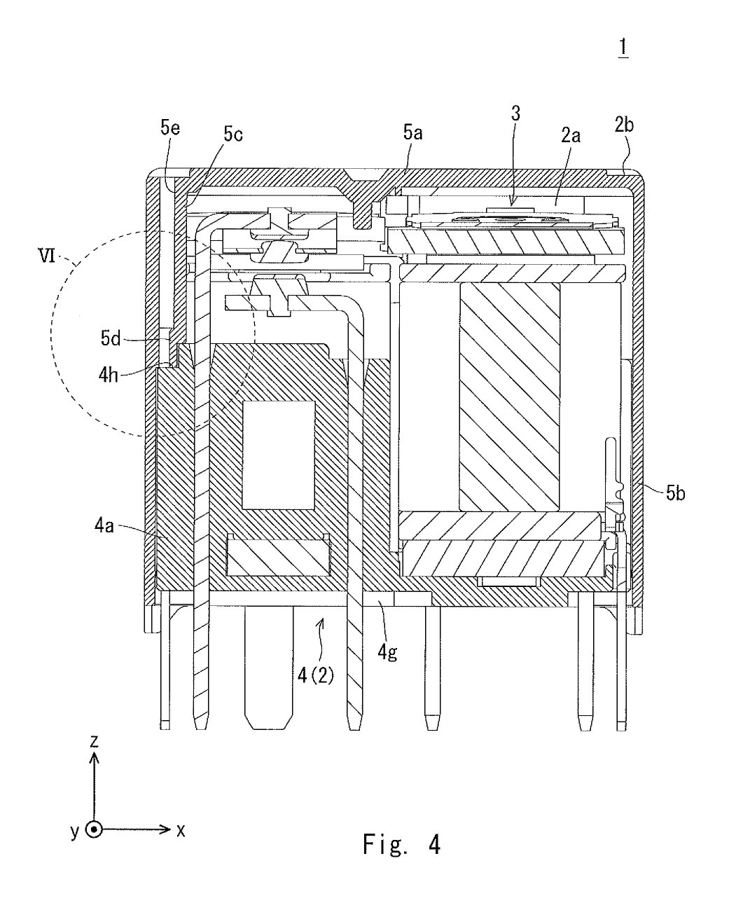

Firstly, a fundamental configuration of an electromagnetic relay according to an embodiment is briefly explained. FIG. 1 is a perspective view schematically showing an electromagnetic relay according to this embodiment. FIG. 2 is an exploded view schematically showing the electromagnetic relay according to this embodiment. FIG. 3 is a cross section taken along a line III-III in FIG. 1. FIG. 4 is a cross section taken along a line IV-IV in FIG. 1.

Note that FIGS. 3 and 4 show a state in which a pressure inside a housing of the electromagnetic relay is equal to or lower than a predetermined pressure. Note that the following explanation is given by using a three-dimensional coordinate system (an xyz-coordinate system) shown in FIG. 1 and the like for clarifying the explanation.

As shown in FIGS. 1 and 2, the electromagnetic relay 1 includes a housing 2 and an electromagnetic relay main body 3. The housing 2 includes a base part 4 on which the electromagnetic relay main body 3 is mounted and a cover part 5 covering the electromagnetic relay main body 3. The above-described housing 2 is formed of an insulating resin material and is put in a sealed state by a sealing resin. Note that specific forms of the base part 4 and cover part 5 will be described later.

As shown in FIG. 2, for example, two electromagnetic relay main bodies 3 are arranged side by side in an x-axis direction and mounted on a surface on a positive side in a z-axis direction (hereinafter expressed as a z-axis positive side) of the base part 4. Further, the two electromagnetic relay main bodies 3 are arranged in a point-symmetric manner around a central axis extending in the z-axis direction in the electromagnetic relay 1. However, the number and arrangement of electromagnetic relay main bodies 3 mounted in the electromagnetic relay 1 are not limited to any particular number and arrangement.

Note that the following explanation of the electromagnetic relay main bodies 3 is given by using the electromagnetic relay main body 3 disposed in the farthest place on the x-axis negative side as an example. The electromagnetic relay main body 3 moves a movable contact 3c disposed at an end on the y-axis positive side in a leaf spring 3b in the z-axis direction by a magnetic attractive force of an electromagnet 3a and thereby changes its electric connection to a first fixed contact 3d or a second fixed contact 3e, which are placed over or under the movable contact 3c in the z-axis direction.

Similarly to an ordinary electromagnet, the electromagnet 3a includes an iron core, a coil, a yoke, and so on. Further, a protrusion (e.g., the yoke) 3f protruding in the y-axis positive direction of the electromagnet 3a is engaged in a first through hole 4b of a protruding part 4a protruding in the z-axis positive direction in the base part 4. Further, a first terminal (an external terminal) 3g through which electric power is externally supplied to the coil of the electromagnet 3a protrudes in the z-axis negative direction from a first cut-out part 4c formed on a fringe of the base part 4.

The leaf spring 3b includes a part 3h extending roughly in the y-axis direction, and a part 3i extending in the z-axis negative direction from an end on the y-axis negative side of the part 3h. Further, an end on the y-axis positive side in the part 3h extending roughly in the y-axis direction, in which the movable contact 3c is disposed, is disposed between the first and second fixed contacts 3d and 3e. Further, a plate-like armature 3j made of a magnetic material is provided in a place that is opposed to the iron core of the electromagnet 3a in the z-axis direction on a surface on the z-axis negative side of the part 3h extending roughly in the y-axis direction.

The part 3i extending in the z-axis negative direction in the leaf spring 3b is fixed to the electromagnet 3a (e.g., the yoke) and a second terminal (an external terminal) 3k is connected to an end on the z-axis negative side of the part 3i. The second terminal 3k protrudes in the z-axis negative direction from a second cut-out part 4d formed in a fringe of the base part 4.

In this way, the iron core of the electromagnet 3a is magnetically joined to the armature 3j by a magnetic force of the electromagnet 3a. Further, when the magnetic force of the electromagnet 3a is turned off, the armature 3j moves away from the iron core of the electromagnet 3a and the movable contact 3c is lifted up toward the z-axis positive side by a restoring force of the leaf spring 3b.

The first fixed contact 3d is provided in a third terminal (an external terminal) 3l. The third terminal 3l includes a part 3m that is provided with the first contact 3d and extends in the x-axis direction, and a part 3n that extends in the z-axis negative direction from an end on the x-axis negative side of the part 3m.

The part 3n extending in the z-axis negative direction of the third terminal 3l is engaged in a second through hole 4e of the protruding part 4a in the base part 4 and its end on the z-axis negative side protrudes in the z-axis negative direction from the base part 4.

The second fixed contact 3e is provided in a fourth terminal (an external terminal) 3o. The fourth terminal 3o includes a part 3p that is provided with the second fixed contact 3e and extends in the x-axis direction, and a part 3q that extends in the z-axis negative direction from an end on the x-axis positive side of the part 3p.

The part 3q extending in the z-axis negative direction of the fourth terminal 3o is engaged in a third through hole 4f of the protruding part 4a in the base part 4 and its end on the z-axis negative side protrudes in the z-axis negative direction from the base part 4.

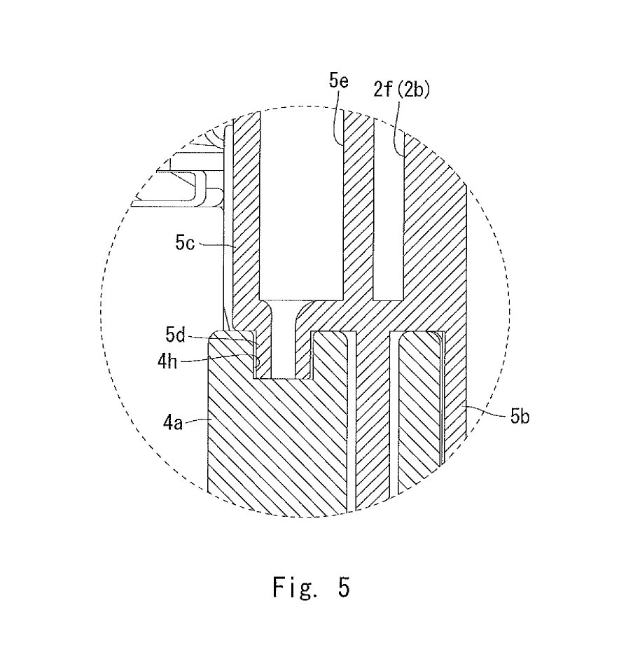

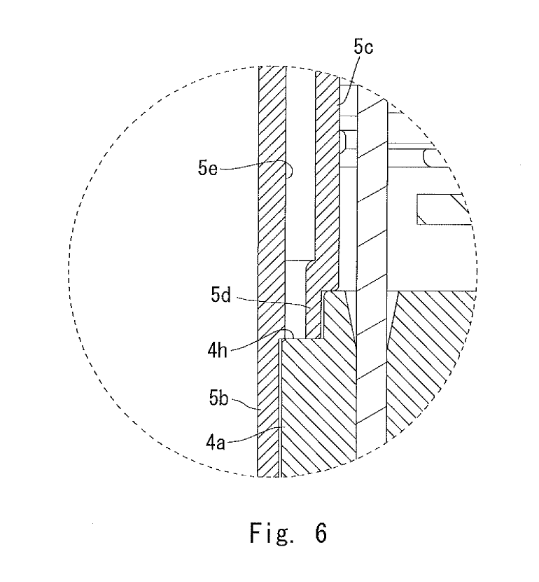

Next, structures of the base part 4 and the cover part 5 of the electromagnetic relay 1 according to this embodiment are explained. Here, FIG. 5 is an enlarged view showing a V-part in FIG. 3 and FIG. 6 is an enlarged view showing a VI-part in FIG. 4.

As shown in FIGS. 2 to 4, the base part 4 includes a plate part 4g having a roughly rectangular shape as viewed in the z-axis direction, and protruding parts 4a protruding in the z-axis positive direction from the aforementioned plate part 4g. The above-described first and second cut-out parts 4c and 4d are formed in the plate part 4g. For example, protruding parts 4a are disposed at opposed corners in the plate part 4g. However, the arrangement and number of protruding parts 4a can be changed as appropriate according to the arrangement and number of pairs of the third terminal 3l and the fourth terminal 3o.

In the protruding part 4a, the above-described first through hole 4b is formed so as to extend in the y-axis direction. Further, the second and third through holes 4e and 4f extending in the z-axis direction are formed with an interval therebetween in the x-axis direction in the protruding part 4a.

As shown in FIGS. 2 to 4, the cover part 5 includes a top plate 5a and a side wall 5b extending in the z-axis negative direction from a fringe of the top plate 5a. Further, a space for accommodating the electromagnetic relay main body 3 (i.e., an internal space 2a of the housing 2) is formed inside the cover part 5.

Further, a gap between the plate part 4g of the base part 4 and the side wall 5b of the cover part 5 is sealed by a sealing resin in a state in which the base part 4 on which the electromagnetic relay main body 3 is mounted is covered by the cover part 5 so that the internal space 2a of the housing 2 is brought into a roughly sealed state.

As shown in FIGS. 3 and 4, a protruding part 5c protruding toward the inside of the cover part 5 is formed in the side wall 5b. The protruding part 5c extends in the z-axis negative direction from the top plate 5a and is disposed on the z-axis positive side with respect to the protruding part 4a of the base part 4.

When the pressure in the internal space 2a of the housing 2 is equal to or lower than a predetermined pressure, the surface on the z-axis negative side in the protruding part 5c is butted against and is in contact with the surface on the z-axis positive side of the protruding part 4a in the base part 4 as shown in FIGS. 5 and 6.

That is, when the pressure in the internal space 2a of the housing 2 is equal to or lower than the predetermined pressure, the butted surfaces, i.e., the surface on the z-axis positive side of the protruding part 4a in the base part 4 and the surface on the z-axis negative side in the protruding part 5c in the cover part 5 form an abutment part.

Note that as shown in FIGS. 5 and 6, in this embodiment, a recess 4h recessed from the protruding part 4a of the base part 4 in the z-axis negative direction is engaged with a projection 5d projecting from the protruding part 5c of the cover part 5 in the z-axis negative direction. Further, at least the butted surfaces, i.e., the surface on the z-axis negative side of the recess 4h (i.e., the bottom surface of the recess 4h) and the surface on the z-axis negative side of the projection 5d (i.e., the top surface of the projection 5d) form the above-described abutment part.

The recess 4h of the base part 4 is, for example, a cut-out part formed in the surface on the outer peripheral side of the electromagnetic relay 1 in the protruding part 4a and extends in the z-axis negative direction from the surface on the z-axis positive side of the protruding part 4a. The projection 5d of the cover part 5 is formed in the protruding part 5c of the cover part 5 so as to conform to the recess 4h of the base part 4. Note that the projection 5d of the cover part 5 is engaged with the recess 4h of the base part 4 in such a manner that it allows the cover part 5 to deform when the pressure in the internal space 2a of the housing 2 rises.

However, the shapes of the recess 4h of the base part 4 and the projection 5d of the cover part 5 are not limited to the above-described shapes. That is, they may have any engaging structure in which the abutment part of the base part 4 and the cover part 5 can be formed and the cover part 5 is allowed to deform when the pressure in the internal space 2a of the housing 2 rises.

As shown in FIGS. 3 and 4, a connection passage 5e that extends from the surface on the z-axis negative side of the projection 5d and reaches the top plate 5a is formed in the protruding part 5c of the cover part 5. For example, the connection passage 5e extends in the z-axis direction, penetrates the protruding part 5c of the cover part 5, and reaches outside of the electromagnetic relay 1.

Therefore, when the pressure in the internal space 2a of the housing 2 is equal to or lower than the predetermined pressure, the connection passage 5e connects the abutment part between the surface on the z-axis negative side of the recess 4h in the base part 4 and the surface on the z-axis negative side of the projection 5d in the cover part 5 to outside of the electromagnetic relay 1.

In the housing 2 having the above-described configuration, when the pressure in the internal space 2a of the housing 2 is equal to or lower than the predetermined pressure, the surface on the z-axis negative side of the recess 4h in the base part 4 is in contact with the surface on the z-axis negative side of the projection 5d in the cover part 5. Therefore, the connection between the internal space 2a of the housing 2 and the connection passage 5e is cut off and hence the internal space 2a of the housing 2 is maintained in the sealed state.

On the other hand, when the pressure in the internal space 2a of the housing 2 rises beyond the predetermined pressure during a soldering process in which the first, second, third and fourth terminals 3g, 3k, 3l and 3o of the electromagnetic relay 1 are connected (e.g., soldered) to a circuit board through a reflow heating process, a gas contained in the internal space 2a of the housing 2 escapes through the connection passage 5e.

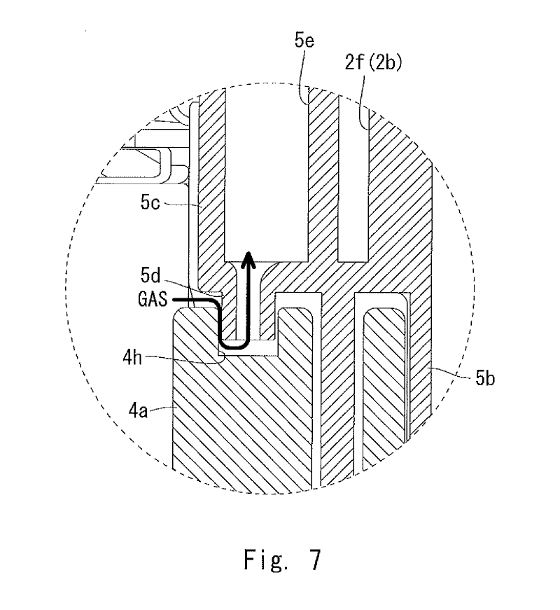

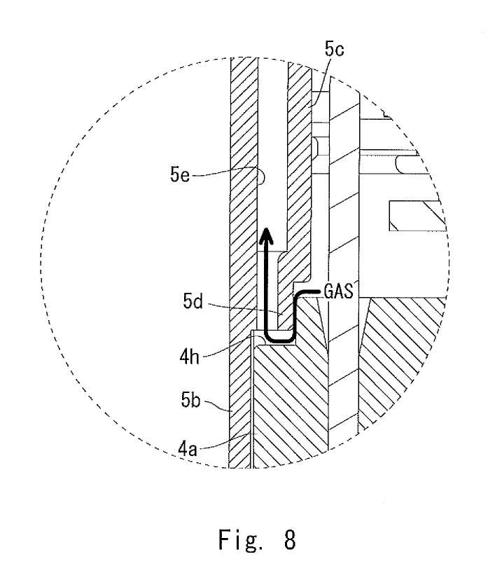

Here, FIG. 7 is an enlarged view corresponding to FIG. 5, showing the housing in a state where the pressure in the internal space of the housing rises beyond the predetermined pressure. FIG. 8 is an enlarged view corresponding to FIG. 6, showing the housing in a state where the pressure in the internal space of the housing rises beyond the predetermined pressure. However, in FIGS. 7 and 8, the gap between the base part and the cover part is shown in an exaggerated manner and the deformation of the cover part is shown in a simplified manner.

When the pressure in the internal space 2a of the housing 2 rises beyond the predetermined pressure, the cover part 5 deforms so that it expands outwardly because the internal space 2a of the housing 2 is roughly in a sealed state. As a result, as shown in FIGS. 7 and 8, the surface on the z-axis positive side of the protruding part 4a in the base part 4 and the surface on the z-axis negative side in the protruding part 5c in the cover part 5 get away from each other. Therefore, the abutment part composed of the surface on the z-axis negative side of the recess 4h in the base part 4 and the surface on the z-axis negative side in the projection 5d in the cover part 5 is separated so that these surfaces relatively move away from each other. Consequently, the internal space 2a of the housing 2 is connected to the connection passage 5e and hence a gas contained in the internal space 2a of the housing 2 escapes to outside of the electromagnetic relay 1 through the connection passage 5e.

As described above, the electromagnetic relay 1 according to this embodiment makes the abutment part between the surface on the z-axis positive side of the protruding part 4a in the base part 4 and the surface on the z-axis negative side of the protruding part 5c in the cover part 5 function as a valve mechanism. Therefore, when the pressure in the internal space 2a of the housing 2 rises beyond the predetermined pressure, the internal space 2a of the housing 2 is connected to the connection passage 5e, thus allowing a gas contained in the internal space 2a of the housing 2 to escape to outside of the electromagnetic relay 1 through the connection passage 5e. Further, these base part 4 and the cover part 5 can be easily formed by, for example, resin molding.

Therefore, in the electromagnetic relay 1 according to this embodiment, there is no need to provide an internal pressure adjustment lid, which is necessary in an ordinary electromagnetic relay, thus making it possible to reduce the number of components and simplify the manufacturing process. As a result, it is possible to suppress a rise in a pressure in the internal space 2a of the housing 2 during a reflow heating process while reducing a cost for manufacturing the electromagnetic relay 1.

In addition, the connection passage 5e is formed in the protruding part 5c of the side wall 5b in the cover part 5 in this embodiment. That is, since the connection passage 5e is formed in a part of the side wall 5b having a large wall-thickness, it is possible to prevent the strength of the side wall 5b from being reduced. Note that by disposing the connection passage 5e in a dead space in the internal space 2a of the housing 2, it is possible to prevent the size of the electromagnetic relay 1 from being increased.

Further, in this embodiment, since the recess 4h of the base part 4 is engaged with the projection 5d of the cover part 5, the passage from the abutment part between the surface on the z-axis negative side of the recess 4h in the base part 4 and the surface on the z-axis negative side of the projection 5d in the cover part 5 to the internal space 2a of the housing 2 has a crank shape. In this way, it means that the following redundant design is made for the housing 2. That is, even if the abutment part between the surface on the z-axis negative side of the recess 4h in the base part 4 and the surface on the z-axis negative side of the projection 5d in the cover part 5 separates (i.e., the surfaces get away from each other) during a reflow heating process in a state where foreign substances are accumulated in the abutment part through the connection passage 5e, there is a place in the passage in which the foreign substances need to move in a direction opposite to the direction of the gravitational force when the direction of the gravitational force defined as the z-axis negative direction. Therefore, the foreign substances hardly flow backward (i.e., hardly flow from outside of the electromagnetic relay 1 to inside thereof) and hardly reach the internal space 2a of the housing 2. Accordingly, it is possible to prevent faulty connection between contacts more reliably.

Note that as shown in FIG. 1 and the like, a heat-radiation part 2b is preferably formed in the housing 2. The heat-radiation part 2b may have any shape by which the surface area of the housing 2 can be increased. For example, the heat-radiation part 2b may be formed in a recessed shape and cooling fins 2e may be formed in the recessed part 2d. In this way, it is possible to dissipate heat generated in the electromagnetic relay main body 3 through the housing 2.

Note that the heat-radiation part 2b is preferably disposed near the first and second fixed contacts 3d and 3e. For example, the heat-radiation part 2b may be disposed at a corner of the cover part 5. In this embodiment, since the protruding part 5c is formed at the corner of the cover part 5, it is possible to form a large heat-radiation part 2b using the large wall-thickness of the protruding part 5c. In this way, it is possible to excellently dissipate heat caused by electric connection between the movable contact 3c and the first or second fixed contact 3d or 3e through the housing 2.

Further, in this embodiment, a recess 2f located near the connection passage 5e disposed in the protruding part 5c is also formed as a heat-radiation part 2b. In this way, it is possible to reduce the wall-thickness of the protruding part 5c around the connection passage 5e. As a result, the cover part 5 can easily deform when the pressure in the internal space 2a of the housing 2 rises beyond the predetermined pressure. Therefore, it is possible to obtain synergistic effects, i.e., obtain both an improvement in the valve function of letting a gas contained in the internal space 2a escape to outside of the electromagnetic relay 1 and an improvement in the heat-radiation property.

Incidentally, the heat-radiation part 2b is preferably disposed in a place other than the central area of the top plate 5a in the cover part 5. In this way, it is possible to convey the electromagnetic relay 1 while sucking up the top plate 5a of the cover part 5 by a sucking mechanism.

The present disclosure is not limited to the above-described embodiments and may be changed as appropriate without departing from the spirit of the present disclosure.

For example, the configuration of the electromagnetic relay main body 3 is not limited to the above-described configuration. That is, the configuration of the electromagnetic relay main body 3 is not limited to any particular configuration.

For example, in the above-described embodiment, the abutment part is formed by the surface on the z-axis positive side of the protruding part 4a in the base part 4 and the surface on the z-axis negative side in the protruding part 5c in the cover part 5. However, the abutment part may be formed by any part in which the base part 4 and the cover part 5 can be butted against each other. Further, the abutment part may be formed by an abutment surface formed by a peripheral area of a recess formed in one of the base part 4 and the cover part 5 and a peripheral area of a projection formed in the other of the base part 4 and the cover part 5.

For example, although the recess 4h of the base part 4 is engaged with the projection 5d of the cover part 5 in the above-described embodiment, a projection formed in the base part 4 may be engaged with a recess formed in the cover part 5.

For example, although the connection passage 5e is formed in the cover part 5 in the above-described embodiment, it may be formed in the base part 4. Further, the connection passage 5e does not necessarily have to extend in the z-axis direction. That is, the only requirement for the connection passage 5e is that it should be able to connect the abutment part between the base part 4 and the cover part 5 to outside of the electromagnetic relay 1.

For example, the heat-radiation part 2b is preferably formed in at least one of the base part 4 and the cover part 5.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An electromagnetic relay comprising a housing comprising a base part on which an electromagnetic relay main body is mounted, and a cover part covering the electromagnetic relay main body, in which the housing is in a sealed state when a pressure inside the housing is equal to or lower than a predetermined pressure, wherein
when the pressure inside the housing is equal to or lower than the predetermined pressure, the cover part and the base part are butted against each other, and the electromagnetic relay comprises a connection passage connecting an abutment part between the cover part and the base part to outside of the electromagnetic relay.

2. The electromagnetic relay according to claim 1, wherein the abutment part is a valve mechanism configured to cut off the connection between the inside of the housing and the connection passage when the pressure inside the housing is equal to or lower than the predetermined pressure, and separate when the pressure inside the housing is higher than the predetermined pressure and thereby connect the inside of the housing with the connection passage.

3. The electromagnetic relay according to claim 1, wherein a projection formed in the cover part is engaged with a recess formed in the base part, and the abutment part is an abutment surface composed of a top surface of the projection in the cover part and a bottom surface of the recess in the base part.

4. The electromagnetic relay according to claim 1, wherein a recess formed in the cover part is engaged with a projection formed in the base part, and the abutment part is an abutment surface composed of a bottom surface of the recess in the cover part and a top surface of the projection in the base part.

5. The electromagnetic relay according to claim 1, wherein the connection passage is formed on a side wall of the cover part.

6. The electromagnetic relay according to claim 1, wherein the connection passage is formed in the base part.

7. The electromagnetic relay according to claim 1, wherein the connection passage extends in a direction in which an external terminal of the electromagnetic relay main body extends.

8. The electromagnetic relay according to claim 1, wherein a heat-radiation part is formed in the housing.

9. The electromagnetic relay according to claim 8, wherein the heat-radiation part is disposed near a movable contact of the electromagnetic relay main body with respect to an electromagnet of the electromagnetic relay main body.

10. The electromagnetic relay according to claim 8, wherein the heat-radiation part is disposed near the connection passage.
